(19) United States
(12) Patent Application Publication
(10) Pub. No.: US 2026/0156266 A1
(43) Pub. Date: Jun. 4, 2026

(54) QUANTIZATION ERROR AWARE FOR LEARNED IMAGE COMPRESSION

(71) Applicant: Samsung Electronics Co., Ltd., Suwon-si (KR)

(72) Inventors: Saifeng Ni, Santa Clara, CA (US); Madhukar Budagavi, Plano, TX (US); Indranil Sinharoy, Richardson, TX (US); Rajan Laxman Joshi, San Diego, CA (US)

(21) Appl. No.: 19/401,234

(22) Filed: Nov. 25, 2025

Related U.S. Application Data
(60) Provisional application No. 63/727,120, filed on Dec. 2, 2024.

(51) Int. Cl. H04N 19/13; H04N 19/124; H04N 19/65; H04N 19/91

(52) U.S. Cl. CPC H04N 19/13; H04N 19/124; H04N 19/65; H04N 19/91

(57) ABSTRACT

Methods and systems for quantization error aware for learned image compression. A method includes receiving an image and mapping the image to a latent representation having one or more channels. The method also includes applying a gain to each of the one or more channels. The method further includes generating a quantized representation by quantizing the latent representation. The method additionally includes generating a bitstream by encoding the quantized representation using entropy encoding. The method also includes decoding the bitstream to generate a reconstructed image.

### CROSS-REFERENCE TO RELATED APPLICATIONS AND CLAIM OF PRIORITY

The present application claims priority to U.S. Provisional Patent Application No. 63/727,120, filed on Dec. 2, 2024. The contents of the above-identified patent documents are incorporated herein by reference.

### TECHNICAL FIELD

The present disclosure relates generally to image processing systems. more specifically, the present disclosure relates to a system and method for quantization error aware for learned image compression.

### BACKGROUND

Tens of millions of images and videos are generated and shared every second on social media. Service providers therefore need more efficient and effective image compression techniques to improve quality of service while saving bandwidth.

Traditional coding methods, such as JPEG, JPEG 2000, BPG, AV1, and VVC, have been iteratively developed and achieve strong performance through thousands of manually engineered components. End-to-end learned image compression provides additional progress and improved rate-distortion performance. Advanced AI technologies may be used to enhance encoders and decoders. Additionally, more sophisticated entropy modeling methods are designed further to analyze the distribution and also the correlation for the latent representation. However, compression performance may still be improved.

Accordingly, there is a need for systems and methods for improved methods of quantization error determination for learned image compression that overcome these challenges.

### SUMMARY

The present disclosure relates generally to image processing systems and, more specifically, the present disclosure relates to a system and method for quantization error aware for learned image compression.

In one embodiment, a method is provided. The method includes receiving an image and mapping the image to a latent representation having one or more channels. The method also includes applying a gain to each of the one or more channels. The method further includes generating a quantized representation by quantizing the latent representation. The method additionally includes generating a bitstream by encoding the quantized representation using entropy encoding. The method also includes decoding the bitstream to generate a reconstructed image.

In another embodiment, an electronic device is provided. The electronic device includes memory and a processor operably coupled to the memory. The processor is configured to receive an image and map the image to a latent representation having one or more channels. The processor is also configured to cause the electronic device to apply a gain to each of the one or more channels. The processor is further configured to cause the electronic device to generate a quantized representation by quantizing the latent representation. The processor is additionally configured to cause the electronic device to generate a bitstream by encoding the quantized representation using entropy encoding. The processor is also configured to cause the electronic device to decode the bitstream to generate a reconstructed image.

In yet another embodiment, a non-transitory computer-readable medium is provided. The non-transitory computer-readable medium includes program code, that when executed by at least one processor of an electronic device, causes the electronic device to receive an image and map the image to a latent representation having one or more channels. The non-transitory computer-readable medium also includes program code, that when executed by the at least one processor, causes the electronic device to apply a gain to each of the one or more channels. The non-transitory computer-readable medium further includes program code, that when executed by the at least one processor, causes the electronic device to generate a quantized representation by quantizing the latent representation. The non-transitory computer-readable medium additionally includes program code, that when executed by the at least one processor, causes the electronic device to generate a bitstream by encoding the quantized representation using entropy encoding. The non-transitory computer-readable medium also includes program code, that when executed by the at least one processor, causes the electronic device to decode the bitstream to generate a reconstructed image.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in accordance with an embodiment of this disclosure;

FIG. 2 illustrates an example electronic device in accordance with embodiments of the present disclosure;

FIG. 3 illustrates an example electronic device in accordance with embodiments of the present disclosure;

FIG. 4 illustrates an example efficiency chart for AI-based LIC methods in accordance with embodiments of the present disclosure;

FIGS. 5A-5B illustrate example learned image compression architectures in accordance with embodiments of the present disclosure;

FIG. 6 illustrates an entropy-based end-to-end learned image compression architecture in accordance with embodiments of the present disclosure;

FIGS. 7A-7B illustrate an example learned image compression pipeline according to embodiments of the present disclosure;

FIGS. 8A-8C illustrate example learned image compression pipelines supporting quantization error aware according to embodiments of the present disclosure; and

FIG. 9 illustrates an example flow chart of a method for quantization error aware for learned image compression according to embodiments of the present disclosure.

### DETAILED DESCRIPTION

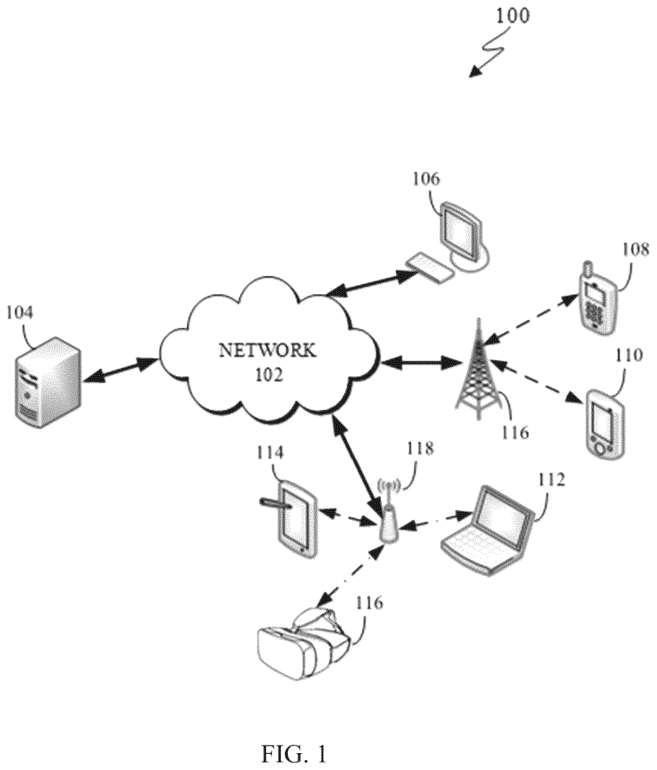

FIG. 1 through FIG. 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, tens of millions of images and videos are generated and shared every second on social media. Service providers therefore need more efficient and effective image compression techniques to improve quality of service while saving bandwidth.

Coding methods, such as JPEG, JPEG 2000, BPG, AV1, and VVC, have been iteratively developed and achieve strong performance through thousands of manually engineered components. On the encoder side, the image is partitioned into blocks. A transform domain is used to decorrelate spatial frequencies via linear transforms (such as DCT or DWT). The transformed coefficients are then quantized, and the quantized values together with prediction side information are entropy coded into a bitstream. On the decoder side, the bitstream is entropy decoded, the coefficients are dequantized, the inverse transform is applied, and the image is reconstructed using the side information.

Learned image and video compression approaches now achieve remarkable performance, in some cases matching or surpassing advanced standards, such as VVC. These AI-based methods jointly optimize the compression pipeline end to end using non-linear transforms, such as convolutional neural networks and related techniques.

End-to-end learned image compression has attracted great attention with promising progress and superior rate-distortion performance. Advanced AI technologies may be used to enhance encoders and decoders. Additionally, more sophisticated entropy modeling methods are designed further to analyze the distribution and also the correlation for the latent representation.

Accordingly, the present disclosure provides systems and methods for quantization error aware for learned image compression. As described herein, the present disclosure includes systems and methods that map an image to a latent representation having one or more channels and apply a gain to each of the one or more channels. A quantized representation is generated by quantizing the latent representation before generating a bitstream by encoding the quantized representation using entropy encoding. The bitstream may be decoded to generate a reconstructed image. The present disclosure, thus, may improve coding performance by further optimizing the quantization stage, which can further enhance the compression performance.

The use of computing technology for media processing is greatly expanding, largely due to the usability, convenience, computing power of computing devices, and the like. Portable electronic devices, such as laptops and mobile smart phones are becoming increasingly popular as a result of the devices becoming more compact, while the processing power and resources included a given device is increasing. Even with the increase of processing power portable electronic devices often struggle to provide the processing capabilities to handle new services and applications, as newer services and applications often utilize more resources that is included in a portable electronic device. Improved methods and apparatus for configuring and deploying media processing in the network are utilized.

Cloud media processing is gaining traction where media processing workloads are set up in the network (e.g., cloud) to take advantage of advantages of the benefits offered by the cloud such as (theoretically) infinite compute capacity, auto-scaling based on need, and on-demand processing. An end user client can request a network media processing provider for provisioning and configuration of media processing functions as desired.

Figures discussed below, and the various embodiments used to describe the principles of the present disclosure in this' patent document are by way of illustration only and should not be construed in any way to limit the scope of the disclosure. Those skilled in the art will understand that the principles of the present disclosure may be implemented in any suitably-arranged system or device.

FIG. 1 illustrates an example communication system 100 in accordance with an embodiment of this disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a wearable device, a HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. In certain embodiments, each server 104 can include an encoder.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and an HMD 116. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications.

In this example, some client devices 108-116 communicate indirectly with the network 102. For example, the mobile device 108 and PDA 110 communicate via one or more base stations 118, such as cellular base stations or eNodeBs (eNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s).

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

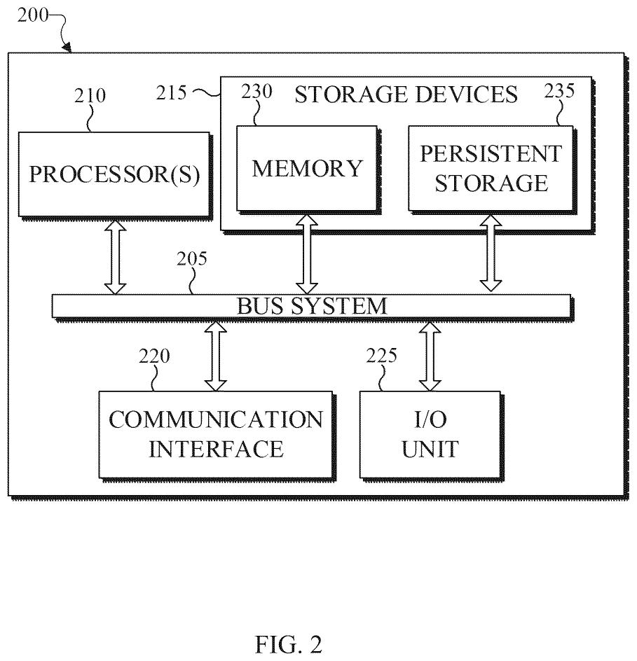

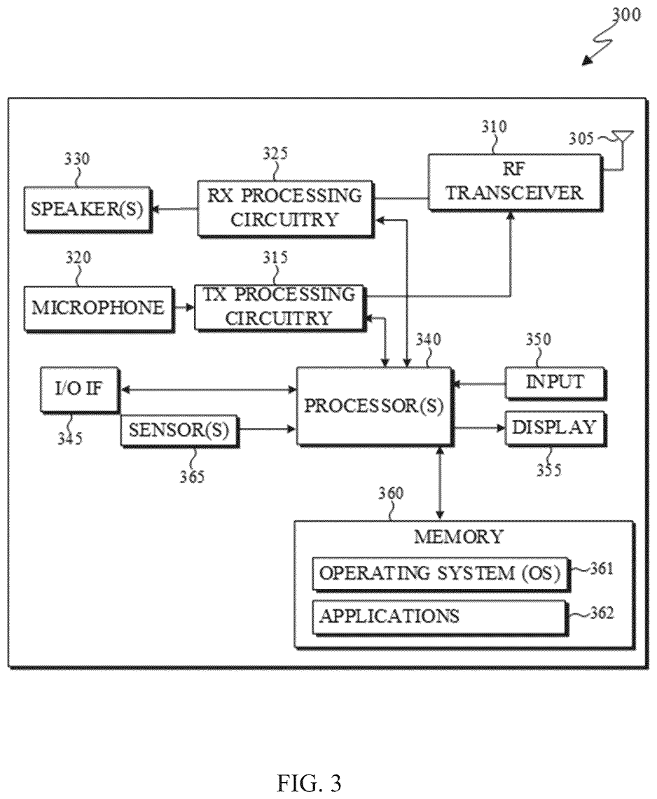

FIGS. 2 and 3 illustrate example electronic devices in accordance with an embodiment of this disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106 116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives, from the antenna 305, an incoming RF signal transmitted from an access point (such as a base station, WI FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user in interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within an HMD. The display 355 can be a singular display screen or multiple display screens capable of creating a stereoscopic display. In certain embodiments, the display 355 is a heads-up display (HUD). The display 355 can display 3D objects, such as a 3D point cloud.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 365 can further include control circuits for controlling any of the sensors included therein.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

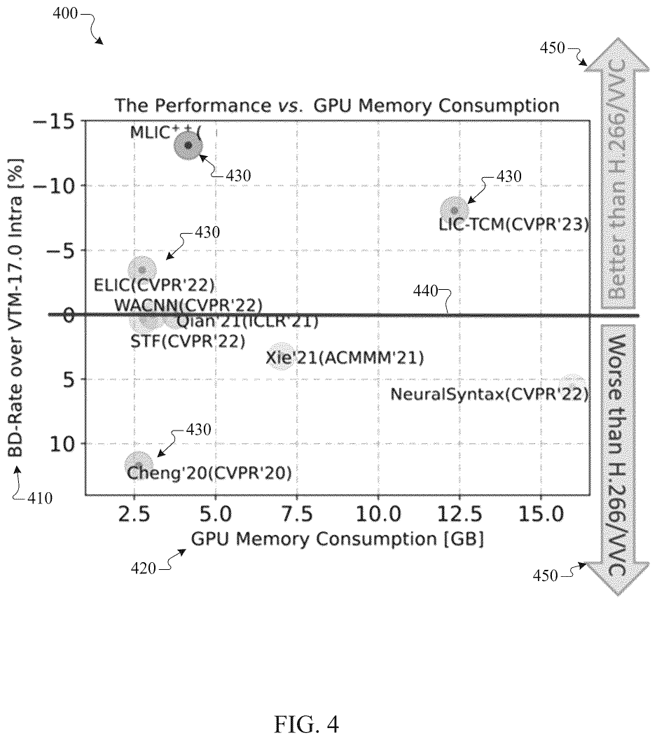

The processing circuitry of the client devices 106-116 may also include one or more image compression models configured to compress and reconstruct images obtained using the one or more sensors, such as the cameras or optical sensors. The one or more compression models may include learned image compression (LIC) models, as shown in FIGS. 4-9.

FIG. 4 illustrates an example performance chart 400 of learned image compression methods according to embodiments of the present disclosure. For ease of explanation, the performance chart 400 will be described as including one or more components of the communication network 100 of FIG. 1, such as the client devices 106-116; however, performance chart 400 could be implemented using any other suitable device or system. The embodiment of the performance chart 400 shown in FIG. 4 is for illustration only. Other embodiments of the performance chart 400 could be used without departing from the scope of this disclosure.

As shown in FIG. 4, the performance chart 400 is based on Bjøntegaard Delta (BD) rate percentage 410 and memory consumption 420. The performance chart 400 includes multiple models 430 arranged based off of their respective BD rate percentage 410 and memory consumption 420. In particular, the multiple models 430 are compared to a neutral line 440, where the respective model does not impact performance positively or negatively. The neutral line 440 is based on a standard 450, which may be an advanced coding method, such as a versatile video coding based on, for example, an H.266 video compression standard.

Some of the multiple models 430 can achieve good performance, while others have already comparable, or even better, performance than the standard 450. The multiple models 430 are able to jointly optimize the image or video compression in an end-to-end pipeline with some non-linear transforms like convolutional neural networks or some other advanced neural network based technologies.

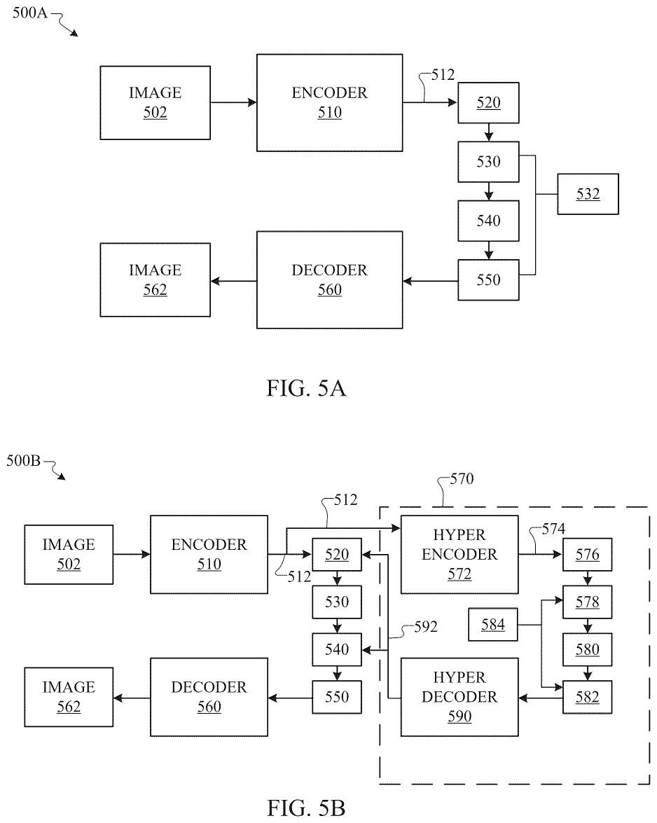

Although FIG. 4 illustrates one example of a performance chart 400, various changes may be made to FIG. 4. For example, various components of FIG. 4 could be combined, further subdivided, or omitted and additional components could be added according to particular needs. Additionally, the performance chart 400 may include performance of AI-based learned image compression methods as shown in FIGS. 5A-5B.

FIGS. 5A-5B illustrate example end-to-end learned image compression architectures 500A, 500B according to embodiments of the present disclosure. For ease of explanation, the end-to-end learned image compression architectures 500A, 500B will be described as including one or more components of the communication network 100 of FIG. 1, such as the client devices 106-116; however, the end-to-end learned image compression architectures 500A, 500B could be implemented using any other suitable device or system. The embodiment of the end-to-end learned image compression architectures 500A, 500B shown in FIGS. 5A-5B is for illustration only. Other embodiments of the end-to-end learned image compression architectures 500A, 500B could be used without departing from the scope of this disclosure.

As shown in FIG. 5A, the LIC architecture 500A includes an encoder 510 configured to receive an image 502. The encoder 510 is configured to generate latent space representation 512 based on the image 502 and pass the latent space representation 512 to a quantization portion 520. The quantization portion 520 quantizes the latent space representation 512 and transmits the quantized latent space representation 512 to an arithmetic encoder 530. The arithmetic encoder 530 generates a bitstream 540 based on the quantized latent space representation 512. The bitstream 540 is then provided to an arithmetic decoder 550 before being provided to a decoder 560 to produce a reconstructed image 562 based on the image 502.

The encoder 510 is a parametric mapping function that transforms high-dimensional input observations into a compact latent representation 512 that captures the salient, task-relevant factors of variation. During training, the encoder 510 is optimized to produce latent variables that are both informative about the image 502 and amendable to the LIC architecture 500 downstream operations. For probabilistic formulations, the encoder 510 outputs sufficient statistics, such as means and variances, or logits used to define a discrete or continuous posterior over latents. The architecture of the encoder 510 determines which aspects of the image 502 are preserved in the latent space.

The quantization portion 520 converts the latent representation 512, such as continuous-valued latent outputs, into a discrete representation suitable for lossless storage or transmission. The quantization of the latent representation 512 allows the latent representation 512 to be used by channels in the LIC architecture 500. The quantization portion 520 may quantize the latent representation 512 using, for example, uniform rounding, vector quantization, learned codebooks, or stochastic quantization. The chosen desired quantization method affects the reconstruction error, codebook use, and how well the entropy model can predict symbol frequencies.

The arithmetic encoder 530 performs arithmetic encoding, a lossless procedure that converts a sequence of discrete latent symbols (such as the quantized latent representation 512) into a compact, near-entropy-limited bit sequence, such as the bitstream 540. The arithmetic encoder 530 consumes probabilities or probability ranges supplied by an entropy model 532 532 and progressively refines ta numeric interval to represent the entire symbol sequence as a single fractional value, which is then emitted as bits. When combined with accurate entropy estimates, arithmetic encoding approaches the theoretical lower bound on average code length, improving compression efficiency over simpler prefix codes.

The bitstream 540 is the serialized sequence of bits produced by the arithmetic encoder 530 and is the physical artifact that is stored or transmitted. If well-formed, the bitstream 540 contains the encoded symbol information and any metadata, such as model identifiers, headers describing quantization parameters, and synchronization markers. The bitstream 540 should be self-consistent and carry sufficient side information for the decoder 560 to reconstruct the image 502.

The entropy model 532 provides probability estimates for each discrete latent symbol conditioned on any available context, such as previously decoded symbols, side information, or learned priors. The entropy model 532 supplies symbol probabilities to the arithmetic encoder 530 to allocate interval mass efficiently during encoding and provides the same probabilities to the decoder 560 to correctly invert the arithmetic coding process. The effectiveness of the entropy model 532 determines how close the realized bit-rate is to the true content of the latent representation 512. As such, improving the entropy model 532 yields measurable gains in compression performance.

The arithmetic decoder 550 functions as the inverse of the arithmetic encoder 530. Given the bitstream 540 and the same entropy model 532, the arithmetic decoder 550 incrementally maps the fractional numeric representation back into the original sequence of discrete latent symbols. Correct arithmetic decoding utilizes strict agreement between the arithmetic encoder 530 and the arithmetic decoder 550 on the entropy model 532, symbol alphabet, and any side information. Mismatches produce decoding errors. The arithmetic decoder 550 also handles implementation details, such as precision limits and underflow/overflow management, to ensure bit-exact recover of the encoded symbols.

The decoder 560 maps the recovered discrete latents back to the observation domain to produce the reconstructed image 562. The decoder 560 may perform a learned inverse mapping that accounts for quantization effects and any stochasticity. Additionally or alternatively, the decoder 560 may combine deterministic upsamples and synthesis modules tuned for minimal reconstruction error. The capacity of the decoder 560 determine reconstruction quality for a given bitrate and the interaction of the decoder 560 with the encoder, the quantization portion 520, and the entropy model 532 defines the overall rate-distortion characteristics of the LIC architecture 500.

In other words, the encoder 510 transforms an image 502 into a latent representation 512. This latent representation 512 is then quantized, entropy coded, and transmitted to the decoder 560, which employs an entropy model 532 to estimate the distribution of the latent variables. The decoder 560 decodes and dequantizes the bitstream 540 and reconstructs the image 502 from the latent representation 512. The training objective is to minimize both the bitstream 540 length and the reconstruction distortion, denoted by L=R+AD. A scaling factor (λ) is introduced to trade off bitrate and distortion based on server-side bitrate requirements. Distortion may be measured using, for example, mean-squared error (MSE) or multi-scale structural similarity (MS-SSIM). Achieving short bitstreams 540 typically utilizes effective analysis/synthesis transforms, accurate probability modeling of the latent representation, and differentiable approximations or relaxations of quantization.

Some approaches report performance superior to JPEG but inferior to H.265/HEVC intra-frame coding. Suppose the image 502 size is W×H, where W and H denote width and height, respectively. Feature extraction in the encoder 510 commonly uses downsampling stages, such as four downsampling layers or stages. The image 502 is downsampled, for example, by a factor of two at each stage while increasing the number of feature channels. The resulting latent representation contains multiple channels N_{c}×W/16×H/16), with the total number of channels denoted by N_{c}.

To further improve performance of the LIC architecture 500, the side information provided to the entropy model 532 may be improved, for example, using hypothesis analysis described in FIG. 5B.

As shown in FIG. 5B, the LIC architecture 500B includes a hypothesis analysis and synthesis portion 570 coupled to receive the latent space representation 512 from the encoder 510. The hypothesis analysis synthesis portion 570 includes a hyper encoder 572, a quantization portion 576, an arithmetic encoder 578, an arithmetic decoder 582, and a hyper decoder 590. The arithmetic encoder 578 and the arithmetic decoder 582 are coupled to an entropy model 584. The hypothesis analysis and synthesis portion 570 is configured to provide side information to the arithmetic encoder 530 and the arithmetic decoder 550 (such as to a main entropy model 532) for arithmetic encoding and decoding, respectively.

The hypothesis analysis and synthesis portion 570 is configured to produce a compact side representation that summarizes uncertainty and context needed to parameterize the primary entropy model. The hyper encoder 572 receives the latent space representation 512 and generates the hypothesis 574, which is a set of coarse latent features that capture spatially-varying statistics, such as local scale, variance, or mixture weights. The hyper encoder 572 is trained jointly with the rest of the LIC architecture 500 so that its outputs provide the entropy model with signals the reduce mismatch between predicted and actual symbol distributions. To do so, however, the hyper encoder 572 trades off the additional side information rate against the improvement in main latent compressibility. The architecture of the hyper encoder 572 (convolutions, downsampling, receptive field) determines the granularity and range of context made available to the entropy model.

The quantization portion 576 of the hypothesis analysis and synthesis portion 570 converts the hypothesis 574 into discrete symbols that can be losslessly encoded and later used to reconstruct the entropy model parameters. During training, differentiable approximations to quantization (such as noise injection, soft rounding, or straight-through estimators) allow gradients to flow so the hyper encoder 572 learns to produce hypothesis values that are both compact under quantization and maximally informative for the entropy model. The quantized hypothesis values form the alphabet over which arithmetic encoding in an arithmetic encoder 578 is applied. The architecture of the quantization portion 576 (such as uniform scalar, learned vector quantizer, or codebook) affects how well the hyperlatent distribution can be predicted by the hyperprior and, therefore, how efficiently the side information itself can be compressed.

The arithmetic encoder 578 converts the sequence of quantized hyperlatent symbols into a tightly packed bitstream 580 according to probability estimates supplied by a hyperprior entropy model. Because the hypothesis analysis and synthesis portion 570 is intended to improve the main entropy model 532, the hyper encoder 572 and the quantization portion 576 must also be supported by their own entropy model, such as a fully factorized or autoregressive model configured to match the hyperlatent distribution, so the arithmetic encoding approaches the per-symbol entropy lower bound. The arithmetic encoder 578 therefore relies on accurate probability mass assignments for each hyper-symbol and any systematic bias in those assignments directly increases the bit cots of the side information and diminishes the net gain from hypothesis conditioning.

The bitstream 580 produce by the arithmetic encoder 578 interleaves or concatenates side information and main latent codes in a suitable form for storage or transmission. The hypothesis analysis and synthesis portion 570 should consider how much side information the bitstream 580 will carry as the decoder 560 must be able to extract and decode the hyperlatents before attempting to decode the primary latents that depend on them. The bitstream 580 format is arranged to preserve this causal ordering and to include synchronization points that the arithmetic decoder 578 and the hyper decoder 590 expect.

The arithmetic decoder 582 is the deterministic inverse of the arithmetic encoder 578 and reconstructs the discrete hyperlatents from the bitstream 580 using the same hyperprior probabilities used during hyper encoding.

The hyper decoder 590, the synthesis stage of the hypothesis, maps the decoded discrete hyperlatents back into continuous parameter fields that condition the main entropy model 532, for example, by introducing spatial maps of scale, means, component weights, distributions, or context vectors used by autoregressive predictors. The side information 592 output of the hyper encoder 572 refines the prior or conditional distribution used to predict each primary latent symbol, enabling a far more accurate entropy model than a fixed, global prior.

The second generation of approaches introduce learning-based context generation, such as hypothesis analysis and hypothesis synthesis for arithmetic encoding and decoding of the latent-space representation. The hypothesis analysis and hypothesis synthesis transmits additional side information, referred to as hyper-priors, to the arithmetic encoder 530 and the arithmetic entropy decoding section 550. Incorporating the generated hyper priors delivers about a 15% to about 20% improvement in compression performance compared with H.265/HEVC intra-frame coding.

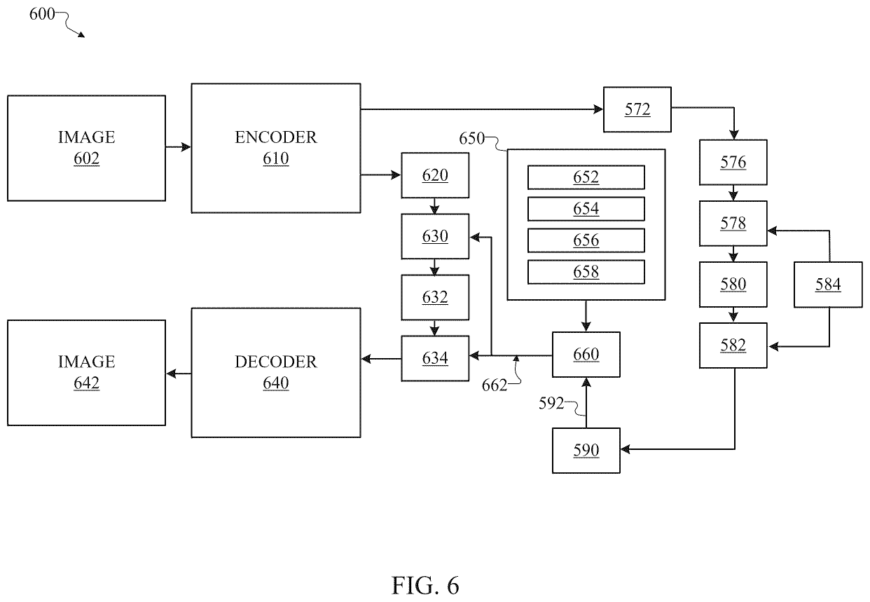

Although FIGS. 5A-5B illustrate examples of end-to-end learned image compression architectures 500A, 500B, various changes may be made to FIGS. 5A-5B. For example, various components of FIGS. 5A-5B could be combined, further subdivided, or omitted and additional components could be added according to particular needs. Additionally, the end-to-end learned image compression architectures 500A, 500B may include entropy encoding as shown in FIG. 6.

FIG. 6 illustrates an example entropy-based end-to-end learned image compression (MLIC) architecture 600 according to embodiments of the present disclosure. For ease of explanation, the MLIC architecture 600 will be described as including one or more components of the communication network 100 of FIG. 1, such as the client devices 106-116; however, the MLIC architecture 600 could be implemented using any other suitable device or system. The embodiment of the MLIC architecture 600 shown in FIG. 6 is for illustration only. Other embodiments of the MLIC architecture 600 could be used without departing from the scope of this disclosure. the MLIC architecture 600 is configured similarly to the LIC architectures 500A, 500B, described in FIGS. 5A-4B except as otherwise described.

As shown in FIG. 6, the MLIC architecture 600 includes an encoder 610 configured to receive an image 602. The MLIC architecture 600 includes a quantization portion 620 and an arithmetic encoder 630 configured to generate a bitstream 632. An arithmetic decoder 634 receives the bitstream 632 and provides an output to a decoder 640, which produces a reconstructed image 642.

The MLIC architecture 600 also includes a multi-reference entropy model (MEM) 650, which replaces the entropy model 532 of the LIC architectures 500A, 500B. The MEM 650 is a learned conditional prior that predicts the discrete probability distribution of each latent symbol by fusing multiple complementary sources of context, such as a hyperprior (global coarse statistics), local spatial neighborhoods, and previously decoded channel or slice references, so that arithmetic coding may operate on tightly conditioned, slice-level distributions and approach the conditional entropy bound.

The MEM 650 includes a channel-wise context layer 652, an attention layer 654 (such as a shifted window-based checkerboard attention layer), an intra-slice global context layer 656, and an inter-slice global context layer 658. The channel-wise context layer 652 divides the latent representation into slices where the channel number for each slice is a hyper parameter. For each slice, the channel-wise context layer 652 captures the channel-wise context from previous slices using, for example, convolution layers to select the most relevant channels and extract information to improve probability estimation. The attention layer 654 is configured to capture local spatial correlations by dividing the latent representation into an anchor part and a non-anchor part. The anchor part is context-free and used to capture the spatial context of the non-anchor part. For example, in a shifted window-based checkerboard configuration, the attention layer 654 stacks an odd number of convolutional layers to transfer information extracted from the anchor part to the non-anchor part using a local receptive field. The attention layer 654 then captures local spatial context by dividing the latent representation into overlapped windows (the local receptive field). To extract the local correlations, the attention map for each window is generated, convoluted to fuse local context information, and provided to a feedforward network for each slice. The intra-slice global context layer 656 aggregates global and local information within the same decode slice, for example, by combining global summary tokens with localized windowed features, to produce spatially-varying parameter maps that sharpen per-location probability estimates for symbols decoded together. The inter-slice global context layer 658 attends from the current slice to stored representations of previously decoded slices so that cross-slice correlations and residual dependencies are exploited to reduce uncertainty.

The MEM 650 outputs to an entropy parameter model 660 which also receives the side information 592 from the hyper decoder 590. The entropy parameter model 660 is a neural subnetwork that consumes fused contextual signals, including hyperprior outputs, intra-slice global context, inter-slice references, and local neighborhood features, and maps them (via an output 662) to the per-symbol parameters of the predictive probability distribution used by the arithmetic encoder 630 and the arithmetic decoder 634.

Some learned image compression approaches employ more advanced feature analysis and feature synthesis methods to enhance coding performance, for example, by using residual networks, transformers, or hybrid transformer-residual architectures to replace conventional CNN models. Other approaches focus on optimizing the entropy model to further reduce redundancy in the latent representation.

The MEM 650 captures different types of correlations present in latent space, achieving strong performance by reducing BD-rate by 11.39% on the Kodak dataset compared with VTM-17.0.

End-to-end learned image compression has attracted significant attention due to its promising progress and superior rate-distortion performance. Advanced AI technologies, such as Mamba, are evolving rapidly. Although CNNs and residual networks are widely used for feature analysis/hyper-analysis and synthesis/hyper-synthesis modules, in certain embodiments the disclosed technology optimizes these modules with advanced AI tools to further improve compression performance.

Feature analysis and synthesis play a critical role in the performance of end-to-end learned image compression. While CNNs and residual blocks are common choices for these modules, in some embodiments the pipeline incorporates AI tools, such as a Swin transformer and a Mamba network, to further enhance end-to-end learned image compression performance.

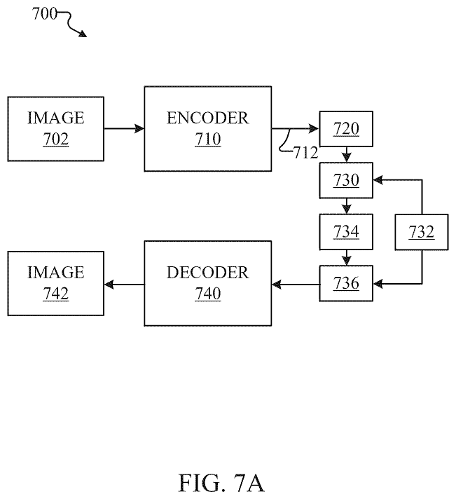

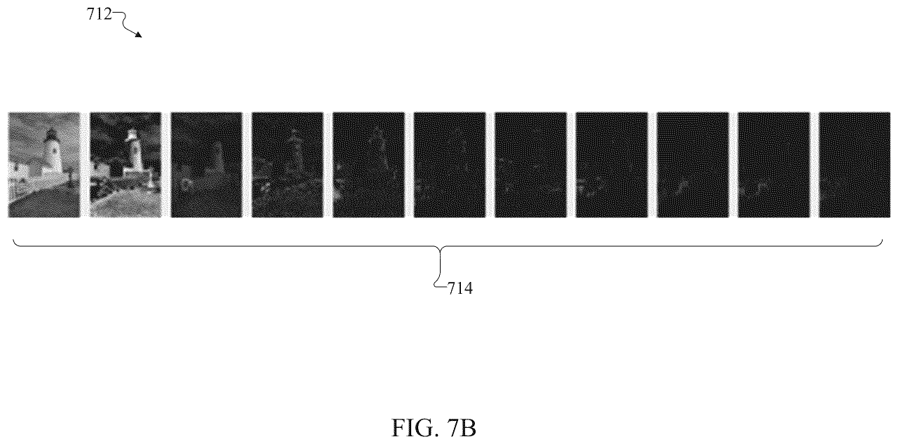

Although FIG. 6 illustrates one example of an entropy-based end-to-end learned image compression architecture 600, various changes may be made to FIG. 6. For example, various components of FIG. 6 could be combined, further subdivided, or omitted and additional components could be added according to particular needs. Additionally, the entropy-based end-to-end learned image compression architecture 600 may include performance-boosting layers, such as a Mamba layer, as shown in FIGS. 7A-7B.

FIGS. 7A-7B illustrate an example learned image compression (LIC) pipeline 700 according to embodiments of the present disclosure. In particular, FIG. 7A illustrates the LIC pipeline 700 and FIG. 7B illustrates a latent representation 712 produced by the LIC pipeline 700. For ease of explanation, the LIC pipeline 700 will be described as including one or more components of the communication network 100 of FIG. 1, such as the client devices 106-116; however, the LIC pipeline 700 could be implemented using any other suitable device or system. The embodiment of the learned image compression pipeline 700 of FIGS. 7A-7B is for illustration only. Other embodiments of the learned image compression pipeline 700 could be used without departing from the scope of this disclosure.

As shown in FIG. 7A, the LIC pipeline 700 includes an encoder 710 configured to receive an image 702 and map the image 702 to a latent representation 712. A quantization portion 720 receives the latent representation 712, quantizes the latent representation 712 to generate a quantized representation 722, then provides the quantized representation 722 to an arithmetic encoder 730. The arithmetic encoder 730 receives input from an entropy model 732 and generates a bitstream 734 based on the quantized representation 722 and input from the entropy model 732. The bitstream 734 is then provided to an arithmetic decoder 736, which also receives input from the entropy model 732 to arithmetically decode the bitstream 734. The decoded bitstream 734 is provided to a decoder 740 for further decoding. The decoder 740 then decodes the output from the arithmetic decoder 736 and generates a restructured image 742.

In a variational autoencoder (VAE)-based end-to-end learned image compression pipeline, the analysis network maps the image 702 to a latent representation. The latent variables are then quantized from real numbers to integers by a quantization portion 720. The quantized representation 722 is lossless-encoded using entropy coding, for example with an arithmetic encoder 730, to produce the bitstream. To further minimize the bitstream size, an entropy model is employed to learn the distribution, for example, the mean μ and scale σ of the distribution, and the correlation structure of the latent representation, commonly referred to as the context model.

Feature analysis and synthesis are key determinants of end-to-end learned image compression performance. The encoder 710 typically includes, for example, four stages for feature extraction. In each stage, the input features are downsampled by a factor of two and expanded into a higher number of channels. The decoder 740 includes, for example, four stages for feature synthesis, where the input features are upsampled by a factor of two. Other neural networks, such as CNNs and residual blocks, are widely used for feature analysis and synthesis in many approaches.

As shown in FIG. 7B, the latent representation 712 includes latent representation channels 714. Redundancy has been observed in latent representations 712 produced by several methods. For example, FIG. 7B illustrates the ten strongest channels 714, highlighting this inefficiency. Some prior methods introduce improved encoder-decoder architectures to enhance feature analysis and synthesis. Other approaches employ sophisticated entropy models, such as context modules, to learn both the distribution and the correlations within the latent representation. However, a key limitation of these end-to-end architectures is their black-box nature, which limits explicit control over internal mechanisms.

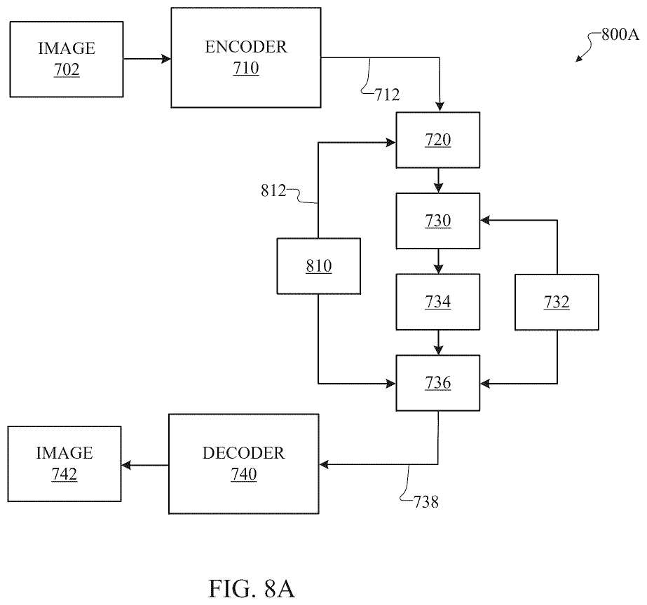

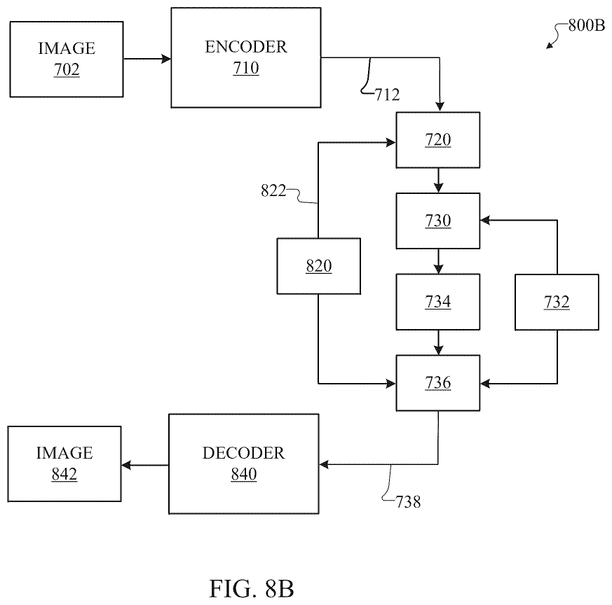

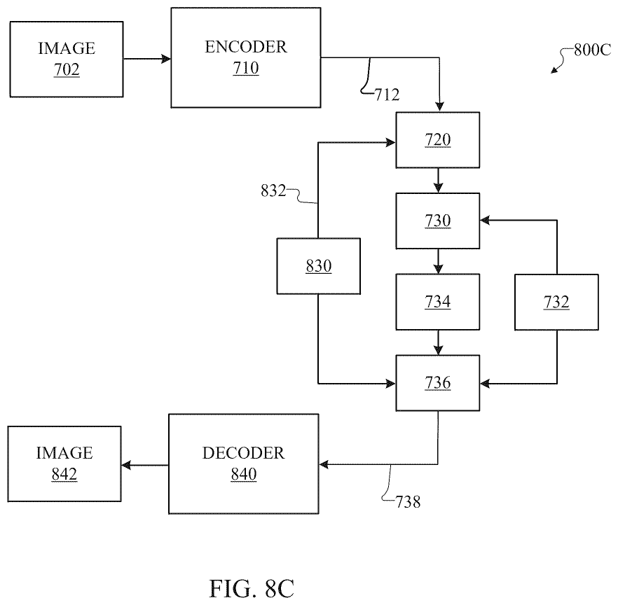

To address this limitation, the QEA-LIC framework (shown in the LIC pipelines 800A-800C of FIGS. 8A-8C) is proposed to apply a gain or scaling factor to each channel of the latent representation 712 before quantization and entropy coding. The objective is to adaptively allocate bits across channels so that channels deemed more important receive more bits, thereby reducing quantization error. These scaling factors are learned through end-to-end LIC training.

The addition of the gain during the LIC pipeline further improves coding performance by focusing on the minimization of quantization error. Rather than introducing complex network modules to decorrelate features, the approach explicitly adjusts the latent representation to reduce quantization error. In particular embodiments, the system allocates additional bits to channels of greater importance during quantization.

Although FIGS. 7A-7B illustrate one example of a learned image compression pipeline 700, various changes may be made to FIGS. 7A-7B. For example, various components of FIGS. 7A-7B could be combined, further subdivided, or omitted and additional components could be added according to particular needs. Additionally, the learned image compression pipeline 700 may include Mamba layers as shown in FIGS. 8A-8C.

FIGS. 8A-8C illustrate example learned image compression (LIC) pipelines 800A-800C supporting quantization error aware according to embodiments of the present disclosure. For ease of explanation, the LIC pipelines 800A-800C will be described as including one or more components of the communication network 100 of FIG. 1, such as the client devices 106-116; however, the LIC pipelines 800A-800C could be implemented using any other suitable device or system. The embodiment of the LIC pipelines 800A-800C shown in FIG. FIGS. 8A-8C is for illustration only. Other embodiments of the LIC pipelines 800A-800C could be used without departing from the scope of this disclosure. The LIC pipelines 800A-800C are configured similarly to the LIC pipeline 700 except as otherwise described.

As shown in FIG. 8A, the LIC pipeline 800A includes a gain calculation function 810 configured to provide a gain 812 to the quantization portion 720. The gain calculation function 810 is configured to generate the gain 812 to reduce quantization error.

The optimization of the LIC pipeline 800A may be formulated as a Lagrange optimization process:

$$L = R ( \hat{y} ) + R ( \hat{z} ) + λ D ( x , \hat{x} ) = E [ - {log}_{2} ( {P}_{\hat{y} \vert \hat{z}} ( \hat{y} \vert \hat{z} ) ) ] + E [ - {log}_{2} ( {P}_{\hat{z}} ( \hat{z} ) ) ] + λ D ( x , \hat{x} \vert \hat{y} ) ,$$

where R is the compression bitrate, D is the distortion between raw image x and the reconstructed image \hat{x}, P_{\hat{z}} is the probability mass function of quantized side information \hat{z}, and P_{ŷ|\hat{z}} (ŷ|\hat{z}) is the Gaussian entropy estimation of quantized latent representation ŷ.

For round quantization for lossless arithmetic coding (such as in the arithmetic encoder 730 and the arithmetic decoder 736), the entropy model 732 of quantized reconstructed latent representation 738 (ŷ) is formulated as the following:

$${P}_{\hat{y} \vert \hat{z}} ( \hat{y} \vert \hat{z} ) = {\prod }_{i} {P}_{\hat{y} \vert \hat{z}} ( \hat{y} \vert \hat{z} ) ,$$

$${P}_{\hat{y} \vert \hat{z}} ( \hat{y} \vert \hat{z} ) = 𝒩 ( {μ}_{i} , {σ}_{i} ) * 𝕌 ( - \frac{1}{2} , \frac{1}{2} ) ( {\hat{y}}_{i} )$$

where ŷᵢ is i-th element of ŷ, and μᵢ, σᵢ are the mean and scale of the estimated Gaussian distribution.

The gain calculation function 810 applies a per-channel gain 812 (Δ_{c}) to each latent representation 712 prior to quantization in the quantization portion 720 and arithmetic entropy coding in the arithmetic encoder 730. The gain 812 is introduced to regulate the quantization error of each channel. This approach may be referred to as Quantization-Error-Aware Learned Image Compression (QEA-LIC), as shown in FIG. 8A. As shown, the LIC pipelines 800A (QEA-LIC) incorporates an additional per-channel scaling factor in both the quantization and entropy coding stages to control the quantization error of the latent representation 712.

The scheme preserves the input to the probability modeling network, thereby keeping the Gaussian entropy estimation of the latent representation 712 nearly unchanged. The gain 812 is employed to tune the quantization bin size.

For each element in the latent representation 712 (yᵢ), the mass cumulative function can be formulated as

$${P}_{\hat{y} \vert \hat{z}} ( \hat{y} \vert \hat{z} , {Δ}_{c} ) = 𝒩 ( {μ}_{i} , {σ}_{i} ) * 𝕌 ( - \frac{1}{2 {Δ}_{c}} , \frac{1}{2 {Δ}_{c}} ) ( {\hat{y}}_{i} )$$

And the quantization error between components of the latent representation 712 (yᵢ) and components of the quantized latent representation 738 (ŷᵢ) is determined by:

$${y}_{i} - {\hat{y}}_{i} = 𝕌 ( - \frac{1}{2 {Δ}_{c}} , \frac{1}{2 {Δ}_{c}} ) .$$

Changing the gain 812 will lead to the change of overall quantization error between the latent representation 712 (y) and the quantized latent representation 738 (ŷ), which will affect the size of the bit stream or the bit allocation. The optimization is changed to be:

$$L = R ( \hat{y} ) + R ( \hat{z} ) + λ D ( x , \hat{x} ) = E [ - {log}_{2} ( {P}_{\hat{y} \vert \hat{z}} ( \hat{y} \vert \hat{z} ) ) ] + E [ - {log}_{2} ( {P}_{\hat{z}} ( \hat{z} ) ) ] + λ D ( x , \hat{x} \vert \hat{y} )$$

Reparameterization is used to make QEA-LIC compatible with LIC methods which use a round quantizer.

$${P}_{\hat{y} \vert \hat{z}} ( \hat{y} \vert \hat{z} ) = 𝒩 ( {Δ}_{c} {μ}_{i} , {Δ}_{c} {σ}_{i} ) * 𝕌 ( - \frac{1}{2} , \frac{1}{2} ) ( {Δ}_{c} {\hat{y}}_{i} )$$

Scaled components of the latent representation 712 (yᵢ) can be quantized by the round quantizer, and the scaled quantized values are used for entropy coding, the inversed scale to get the components of the quantized latent representation 738 (ŷᵢ) using the following:

$$Quantization : {q}_{c , i , j} = round ( \frac{{y}_{c , i , j}}{{Δ}_{c}} ) , c = 0 , … , {N}_{c}$$

$$DeQuantization : {\hat{y}}_{c , i , j} = {q}_{c , i , j} * {Δ}_{c} , c = 0 , … , {N}_{c}$$

These scaling factors are additional trainable parameters within the LIC pipeline 800A. The LIC pipeline 800A produces an about 1.658% BD-rate reduction when compared to standard LIC models. Further details are provided in Table 1. Each column corresponds to a different bit rate, λ.

TABLE 1
Quantization Error Aware Applied to MLIC

| | | | | | | Bitrate |
|---|---|---|---|---|---|---|
| | λ | 0.0018 | 0.0067 | 0.025 | 0.0483 | savings |
| Baseline | PSNR | 28.7157 | 31.6417 | 34.9262 | 36.6886 | |
| | Bitrate | 0.1282 | 0.3158 | 0.7110 | 1.0201 | |
| QEA-LIC | PSNR | 29.0231 | 31.8987 | 35.1890 | 36.8053 | |
| | Bitrate | 0.1314 | 0.3361 | 0.7485 | 1.0426 | −1.658% |

The gain 812 may also be applied to the arithmetic decoder 736 as a decoding gain.

As shown in FIG. 8B, the LIC pipeline 800B includes a slice gain calculation function 820 configured to provide a gain 822, a per-slice gain factor, to the quantization portion 720. The gain calculation function 820 is configured to generate the gain 822 to reduce quantization error.

The gain 822 (Δₛ) is applied for multiple slices of a channel in the latent representation 712. Assuming the slice size is k, then the following applies:

$$Quantization : {q}_{c , i , j} = round ( \frac{{y}_{c , i , j}}{{Δ}_{s} ( \frac{c}{k} )} ) , c = 0 , … , {N}_{c}$$

$$DeQuantization : {\hat{y}}_{c , i , j} = {q}_{c , i , j} * {Δ}_{s} ( \frac{c}{k} ) , c = 0 , … , {N}_{c}$$

The slice gain calculation function 820 applies the gain 822 (Δₛ) to each latent representation 712 prior to quantization in the quantization portion 720 and arithmetic entropy coding in the arithmetic encoder 730 to correct quantization error on a per-slice basis.

As shown in FIG. 8C, the LIC pipeline 800C includes a variable gain calculation function 830 configured to provide a variable gain 832 to the quantization portion 720. The variable gain calculation function 830 is configured to generate the variable gain 832 to reduce quantization error.

The LIC pipeline 800C is configured to support variable bitrates with a single model. Rather than relying on separate models that must be trained for different compression rates, and distinct training configurations are used for each target compression rate. The variable gain calculation function 830 applies the variable gain 832 (α_{c}/αₛ), which is a bit rate scaling factor based on a variable bit rate for each channel c and channel slice s. A scaling factor αᵢⱼ may be associated with each channel/slice i at different bitrates j.

Although FIGS. 8A-8C illustrates example LIC pipelines 800A-800C supporting quantization error aware, various changes may be made to FIGS. 8A-8C. For example, various components of FIGS. 8A-8C could be combined, further subdivided, or omitted and additional components could be added according to particular needs.

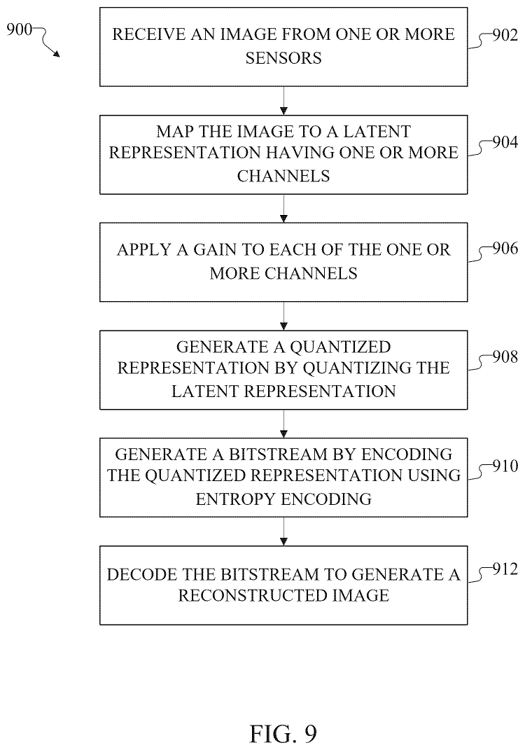

FIG. 9 illustrates an example method 900 for quantization error aware for learned image compression according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of quantization error aware for learned image compression could be used without departing from the scope of this disclosure.

As shown in FIG. 9, an image is received from the one or more sensors at step 902. For example, one or more optical sensors or cameras of the electronic device 300 may obtain an image 702 and provide the image 702 to the LIC pipeline 700.

The image is mapped to a latent representation having one or more channels at step 904. For example, the encoder 710 of the LIC pipeline 700 receives an image 702 and maps the image 702 to a latent representation 712.

A gain is applied to each of the one or more channels at step 906. For example, the gain calculation function 810 may generate the gain 812 and apply the gain 12 to one or more channels 714 of the latent representation 712. Additionally or alternatively, the gain 822, a per-slice channel gain, may be applied to each slice of each of the one or more channels 714 in the latent representation 712. Additionally or alternatively, the variable gain 832 may be applied to the one or more channels 714 of the latent representation 712.

A quantized representation is generated by quantizing the latent representation at step 908. For example, the quantization portion 720 receives the latent representation 712 from the encoder 710. The quantization portion 720 also receives the gain 812 to correct for quantization error in the quantization portion 720. The quantization portion 720 then quantizes the latent representation 712 to generate a quantized representation 722.

A bitstream is generated by encoding the quantized representation using entropy encoding at step 910. For example, the arithmetic encoder 730 receives input from an entropy model 732 and generates a bitstream 734 based on the quantized representation 722 and input from the entropy model 732.

The bitstream is decoded to generate a reconstructed image at step 910. For example, the decoder 740 decodes the output from the arithmetic decoder 736 and generates a restructured image 782. Decoding the bitstream 734 to generate the reconstructed image 742 may include applying a decoding gain, such as the gain 812, to the bitstream 734 and decoding the bitstream 734 based on the decoding gain using entropy decoding. Additionally or alternatively, the gain applied during step 906 may be applied to the arithmetic decoder 736 to produce a reconstructed latent representation 738 that is provided to the decoder 740. The decoder 740 then generates the reconstructed image 742 based on the received reconstructed latent representation 738.

Although FIG. 9 illustrates one example method for quantization error aware for learned image compression, various changes may be made to FIG. 9. For example, while shown as a series of steps, various steps in FIG. 9 could overlap, occur in parallel, occur in a different order, or occur any number of times.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
receiving an image;
mapping the image to a latent representation having one or more channels;
applying a gain to each of the one or more channels;
generating a quantized representation by quantizing the latent representation;
generating a bitstream by encoding the quantized representation using entropy encoding; and
decoding the bitstream to generate a reconstructed image.

2. The method of claim 1, wherein the gain adjusts a quantization bin size for a respective channel of the one or more channels.

3. The method of claim 1, wherein the gain is configured to adjust a quantization error between the latent representation and the bitstream.

4. The method of claim 1, wherein decoding the bitstream to generate the reconstructed image comprises:
applying a decoding gain to the bitstream; and
decoding the bitstream based on the decoding gain using entropy decoding.

5. The method of claim 4, wherein the decoding gain is based on the gain applied to each of the one or more channels before quantization of the image.

6. The method of claim 1, wherein:
at least one of the one or more channels includes multiple channel slices; and
the gain comprises a slice gain that is applied to each of the multiple channel slices.

7. The method of claim 6, wherein the slice gain comprises a bit rate scaling factor based on a variable bit rate of each of the multiple channel slices.

8. An electronic device, comprising:
memory; and
a processor operably coupled to the memory, configured to cause the electronic device to:
receive an image from the one or more sensors;
map the image to a latent representation having one or more channels;
apply a gain to each of the one or more channels;
generate a quantized representation by quantizing the latent representation;
generate a bitstream by encoding the quantized representation using entropy encoding; and
decode the bitstream to generate a reconstructed image.

9. The electronic device of claim 8, wherein the gain adjusts a quantization bin size for a respective channel of the one or more channels.

10. The electronic device of claim 8, wherein the gain is configured to adjust a quantization error between the latent representation and the bitstream.

11. The electronic device of claim 8, wherein the processor, when causing the electronic device to decode the bitstream to generate the reconstructed image, is further configured to cause the electronic device to:
apply a decoding gain to the bitstream; and
decode the bitstream based on the decoding gain using entropy decoding.

12. The electronic device of claim 11, wherein the decoding gain is based on the gain applied to each of the one or more channels before quantization of the image.

13. The electronic device of claim 8, wherein:
at least one of the one or more channels includes multiple channel slices; and
the gain comprises a slice gain that is applied to each of the multiple channel slices.

14. The electronic device of claim 13, wherein the slice gain comprises a bit rate scaling factor based on a variable bit rate of each of the multiple channel slices.

15. A non-transitory computer-readable medium comprising program code, that when executed by at least one processor of an electronic device, causes the electronic device to:
receive an image;
map the image to a latent representation having one or more channels;
apply a gain to each of the one or more channels;
generate a quantized representation by quantizing the latent representation;
generate a bitstream by encoding the quantized representation using entropy encoding; and
decode the bitstream to generate a reconstructed image.

16. The non-transitory computer-readable medium of claim 15, wherein the gain adjusts a quantization bin size for a respective channel of the one or more channels.

17. The non-transitory computer-readable medium of claim 15, wherein the gain is configured to adjust a quantization error between the latent representation and the bitstream.

18. The non-transitory computer-readable medium of claim 15, wherein the program code, that when executed by the at least one processor, causes the electronic device to decode the bitstream to generate the reconstructed image, further comprises program code, that when executed by the at least one processor, causes the electronic device to:
apply a decoding gain to the bitstream, wherein the decoding gain is based on the gain applied to each of the one or more channels before quantization of the image; and
decode the bitstream based on the decoding gain using entropy decoding.

19. The non-transitory computer-readable medium of claim 15, wherein:
at least one of the one or more channels includes multiple channel slices; and
the gain comprises a slice gain that is applied to each of the multiple channel slices.

20. The non-transitory computer-readable medium of claim 19, wherein the slice gain comprises a bit rate scaling factor based on a variable bit rate of each of the multiple channel slices.
